(19) United States
(12) Patent Application Publication
(10) Pub. No.: US 2017/0133910 A1
(43) Pub. Date: May 11, 2017

(54) TOWER BASED KINETIC ENERGY GENERATION METHOD AND DEVICE THEREOF

(71) Applicant: Hsien-Ming Lin, Hsinchu County (TW)

(72) Inventor: Hsien-Ming Lin, Hsinchu County (TW)

(21) Appl. No.: 15/410,722

(22) Filed: Jan. 19, 2017

Related U.S. Application Data
(63) Continuation-in-part of application No. 14/804,349, filed on Jul. 21, 2015.

(51) Int. Cl. H02K 7/18; F03B 17/00; F03B 11/00

(52) U.S. Cl. CPC H02K 7/1823; F03B 11/004; F03B 17/005; Y10S 415/916

(57) ABSTRACT

A tower-based kinetic energy generation method and device, generally including two buckets that are movable up and down alternately to carry water to an upper location to allow water to rush down to impact and drive power generation units to generate electrical power thereby achieving circulative power generation. The two buckets are mounted to a tower frame and are driven by a drive unit to move. The tower frame has a bottom in which a water storage trough is formed. Rotary mechanisms are arranged above the water storage trough and the rotary mechanisms are coupled to power generation units. Two sides of the tower frame are each provided with a water storage tank. The water storage tank has a bottom from which a pipe extends to a location above the respective rotary mechanism.

### CROSS-REFERENCE TO RELATED APPLICATION

This is a continuation-in-part of co-pending U.S. patent application Ser. No. 14/804,349 filed on Jul. 21, 2015 and owned by the present applicant.

### (a) TECHNICAL FIELD OF THE INVENTION

The present invention relates generally to a tower based kinetic energy generation method and a device thereof, and more particularly to a method for generating kinetic energy through water impacting a kinetic energy generation unit and a device thereof.

### (b) DESCRIPTION OF THE PRIOR ART

The continuous consumption of natural resources of the Earth brings a severe issue of global warming and also leads to a potential concern of exhaustion of the natural resources. In everyday living or industrial production processes, power is often used to carry out such as grinding and driving. The supply of such power is generally based on active elements that consume a relatively large amount of electrical power, such as motors and drivers. Thus, most of the countries started projects of generating kinetic energy in a “natural” way, and generation of electrical power in a natural way has been most seriously developed. However, in addition to the development of generating electrical power with a natural way, methods or means that help supply a large amount of kinetic energy by consuming a relatively small amount of electrical power should also be seriously considered and developed. The present invention is aimed to provide a tower based kinetic energy generation device that generates kinetic energy through water impacting a kinetic energy generation unit to thereby achieve protection of the environment.

### SUMMARY OF THE INVENTION

The primary objective of the present invention is to provide a tower-based kinetic energy generation method and a device thereof, which generate kinetic energy through water impacting a kinetic energy generation unit to supply kinetic energy for grinding and driving for the purpose of saving energy and protecting the environment.

The tower-based power generation method and device uses two buckets that are movable alternately up and down to carry water to an upper location to allow water to rush down to impact and drive a kinetic energy generation unit to generate kinetic energy.

In the above tower-based power generation method and device, a tower frame is provided. The tower frame comprises a first bucket and a second bucket mounted thereto to be driven and moved by a drive unit. The tower frame has a bottom in which a water storage trough is formed. A kinetic energy generation unit is arranged above the water storage trough. The tower frame comprises a water storage tank mounted thereto. The water storage tank has a bottom from which a pipe extends to a location above and corresponding to the kinetic energy generation unit. The drive unit drives the first bucket and the second bucket to alternately move up and down to carry water from the water storage trough to the upper part of the tower frame to be poured into the water storage tank, allowing water to flow down along the pipe to impact and drive the kinetic energy generation unit to generate kinetic energy. Water that flows down the pipe is allowed to flow back into the water storage trough for cyclic generation of kinetic energy.

In the above tower-based power generation method and device, stop pieces are respectively arranged at locations above the water storage tank of the tower frame, so that when the buckets are driven to the locations of the stop pieces, the engagements of the stop pieces with the buckets cause the buckets to rotate by an angle to pour water into the water storage tank.

In the above tower-based power generation method and device, the drive unit is mounted to a top of the tower frame to rotate forwards and backwards for driving the buckets to move up and down.

In the above tower-based power generation method and device, the first bucket and the second bucket each have a bottom having an inside surface on which a retention member is mounted. A valve plate is rotatably coupled to the retention member so that the valve plate is made movable with the retention member being a support point. When the first bucket or the second bucket is dipped into the water storage trough, water pressure causes the valve plate to move upward and disengage from an opening to allow water to flow through the opening into the first bucket or the second bucket, which when filled up with water, generates a water pressure therein and the valve plate is pushed down to get fit into the opening, preventing water from flowing out of the first bucket or the second bucket thereby achieving an effect of holding water therein.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a structure of the present invention.

FIG. 2 is a perspective view showing a bucket according to the present invention.

FIG. 3 is a cross-sectional view of the bucket of the present invention.

FIGS. 4 and 5 are schematic views illustrating an operation of the bucket of the present invention.

FIG. 6 is a schematic view illustrating an operation of the present invention.

FIG. 7 is another schematic view illustrating an operation of the present invention.

FIGS. 8 and 9 are schematic views illustrating an operation of another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

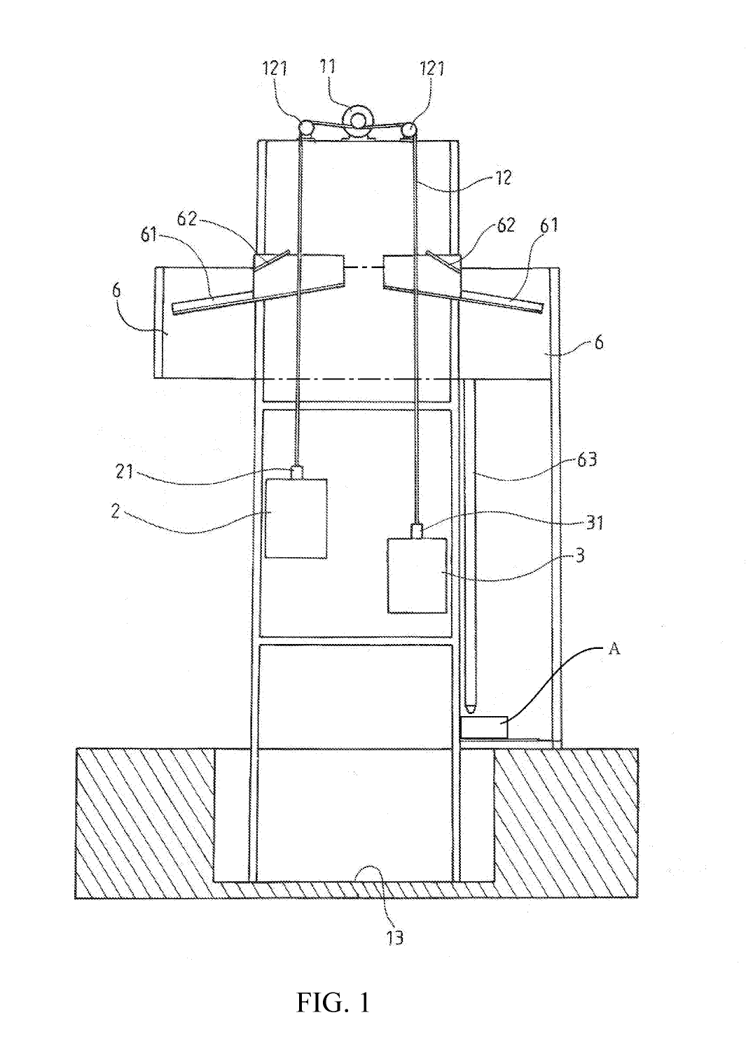

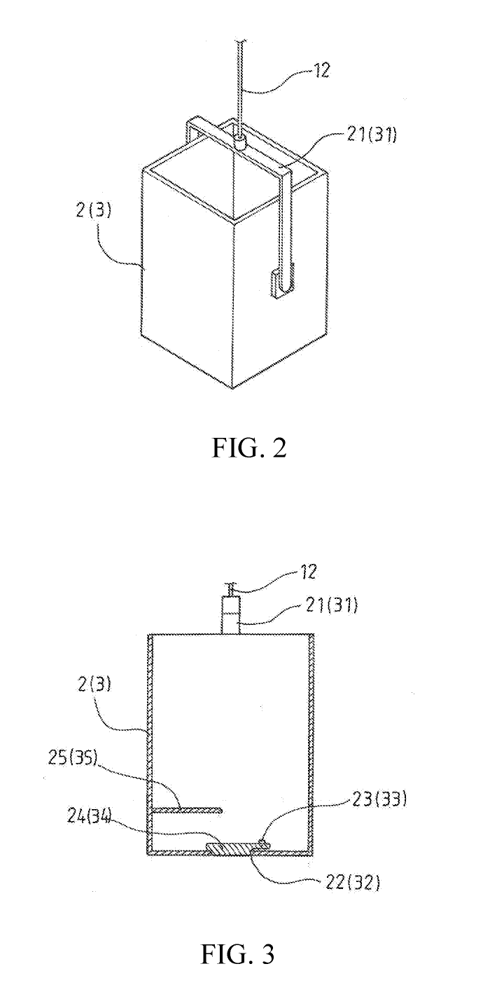

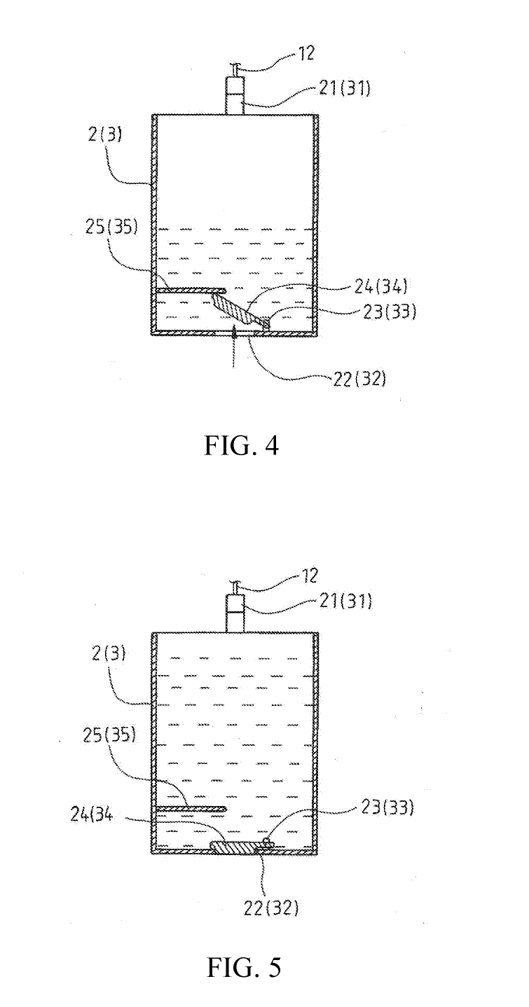

Referring collectively to FIGS. 1 and 2, in combination with FIG. 3, which are respectively a schematic view showing a structure of the present invention, a perspective view showing a bucket according to the present invention, and a cross-sectional view of the bucket of the present invention, as shown in the drawings, the present invention comprises a tower frame 1. A drive unit 11 (a variable frequency drive motor) is mounted to a top of the tower frame 1. A cable 12 is coupled to the drive unit 11 and arranged in such a way that the cable 12 extends over idle pulleys 121 to have two ends of the cable 12 respectively coupled to a first bucket 2 and a second bucket 3. The tower frame 1 has a bottom in which a water storage trough 13 is provided. A kinetic energy generation unit A is mounted atop the water storage trough 13.

The first bucket 2 and the second bucket 3 are each provided with an inverted U-shaped handle 21, 31 in such a way that two ends of the handle 21, 31 are respectively and pivotally connected to opposite sides of the bucket 2, 3 to show a movable arrangement therebetween and each bucket has a bottom wall in which an opening 22, 32 is formed and comprises a retention member 23, 33 mounted to an inside surface of the bottom wall in such a way that the retention member 23, 33 is rotatably coupled to a valve plate 24, 34 to allow the valve plate 24, 34 to show a movable arrangement with the retention member 23, 33 being a support point so that the valve plate 24, 34 is selectively movable into and thus close the opening 22, 32 or is movable upward to disengage from the opening 22, 32. A stop plate 25, 35, which extends horizontally from a side wall of the bucket 2, 3, is provided above the valve plate 24, 34.

The tower frame 1 comprises a water storage tank 6 mounted thereto. An inclined water chute 61 is arranged above the water storage tank 6 to be associated with each of the first and second buckets. A stop piece 62 that is inclined is provided above the water chute 61. The water storage tank 6 has a bottom from which a pipe 63 extends to a location above and corresponding to the kinetic energy generation unit A.

With the above arrangement of the components, a tower-based kinetic energy generation device is formed. The drive unit 11 drives the first bucket 2 and the second bucket 3 to move in such a way that, with the first bucket 2 and the second bucket 3 being counterweight of each other, the first bucket 2 the second bucket 3 are alternately moved up and down to carry water from the water storage trough 13 to a location at an upper part of the tower frame 1 to be poured into the water storage tank 6, whereby water received in the water storage tank 6 is allowed to rush down along the pipe 63 to impact and drive the kinetic energy generation unit A to generate kinetic energy that can be used for various purposes, such as grinding and driving. In this way, an effect that a relatively large amount of kinetic energy is generated cyclically through consumption of a relatively small amount of electrical power thereby achieving an effect of energy saving and environment protection.

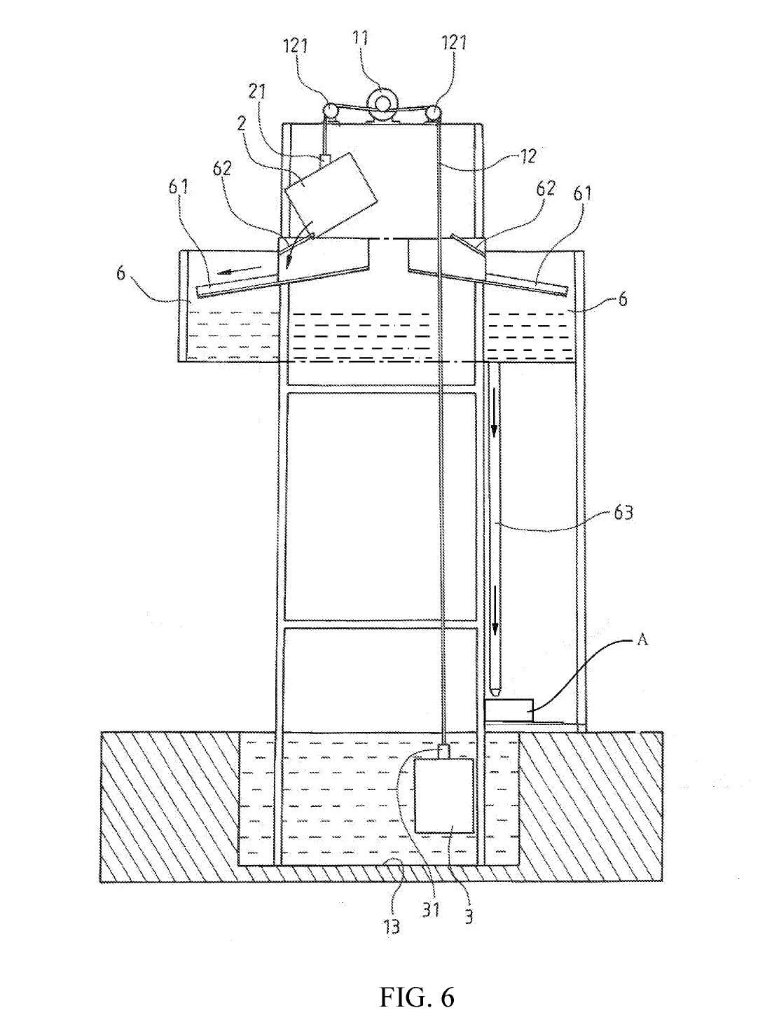

Referring collectively to FIGS. 4 and 5, schematic views are given to illustrate an operation of the bucket of the present invention. As shown in the drawings, according to the present invention, the first bucket 2 and the second bucket 3 each comprise a retention member 23, 33 mounted to the inside surface of the bottom of the bucket and the retention member 23, 33 is rotatably coupled to the valve plate 24, 34, so as to render the valve plate 24, 34 movable with the retention member 23, 33 being a support point. When the first bucket 2 or the second bucket 3 is dipped into the water storage trough 13, due to water pressure of the water storage trough 13, the valve plate 24, 34 is pushed to move upward and thus, the valve plate 24, 34 disengages from the opening 22, 32 to allow water to flow through the opening 22, 32 into the interior of the first bucket 2 or the second bucket 3. When the valve plate 24, 34 is moved upward, the stop plate 25, 35 help to stop the movement thereof so as to prevent the valve plate 24, 34 from being rotated upward by an excessive angle that prevents returning of the valve plate. When the first bucket 2 or the second bucket 3 receives and holds therein a predetermined amount of water, water contained in the first bucket 2 or the second bucket 3 pushes down the valve plate 24, 34 to fit into the opening 22, 32, thereby preventing water from flowing outward from the first bucket 2 or the second bucket 3. As such, containing and holding water can be achieved.

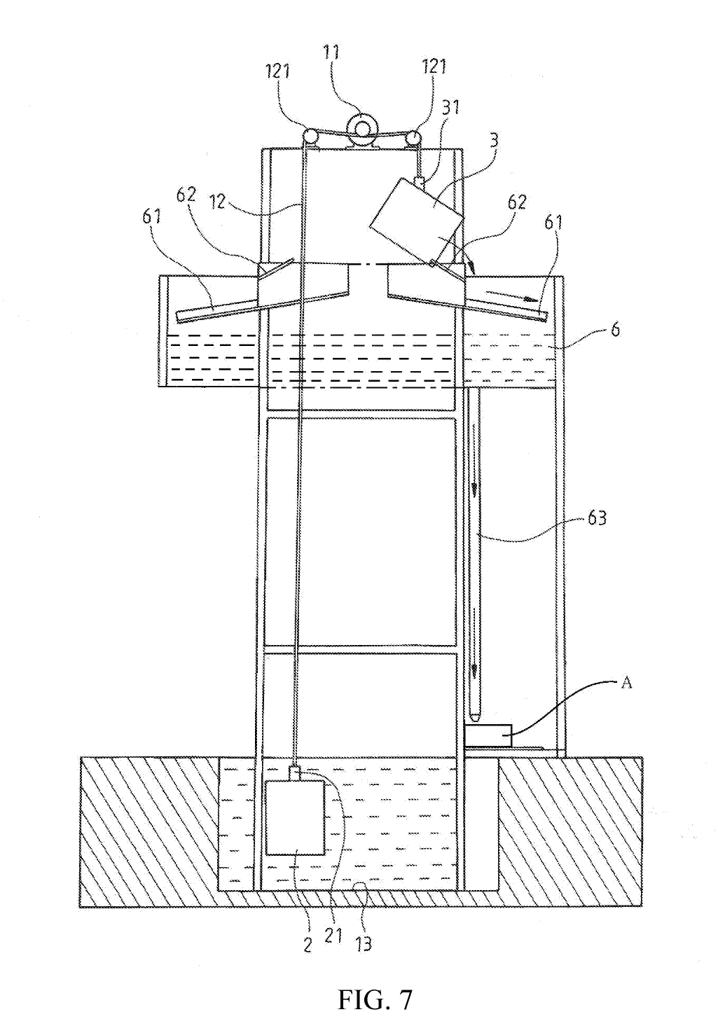

Referring to FIG. 6, a schematic view is given to illustrate an operation of the present invention. Reference being also had to FIGS. 4 and 5, as shown in the drawings, when the present invention is put into operation, the drive unit 11 drives the bucket 2 to alternately move up and down so that the first bucket 2 is dipped into the water storage trough 13 to have the first bucket 2 filled with water (as shown in FIGS. 4 and 5) and then the first bucket 2 is moved to an upper part of the tower frame 1, wherein when the first bucket 2 passes through the stop piece 32 arranged at the upper part of the tower frame 1, the engagement thereof with the stop piece 32 makes the first bucket 2 rotate downward by an angle to have water poured into the water chute 31 to flow into the water storage tank 6 and then flow downward along the pipe 63 to impact and drive the kinetic energy generation unit A. Water that flows down along the pipe 63 is then allowed to flow back into the water storage trough 13 to achieve an effect of cyclic generation of kinetic energy. At this moment, the second bucket 3, due to the upward movement of the first bucket 2, is driven down to dip into the water storage trough 13 and filled with water (as shown in FIGS. 4 and 5).

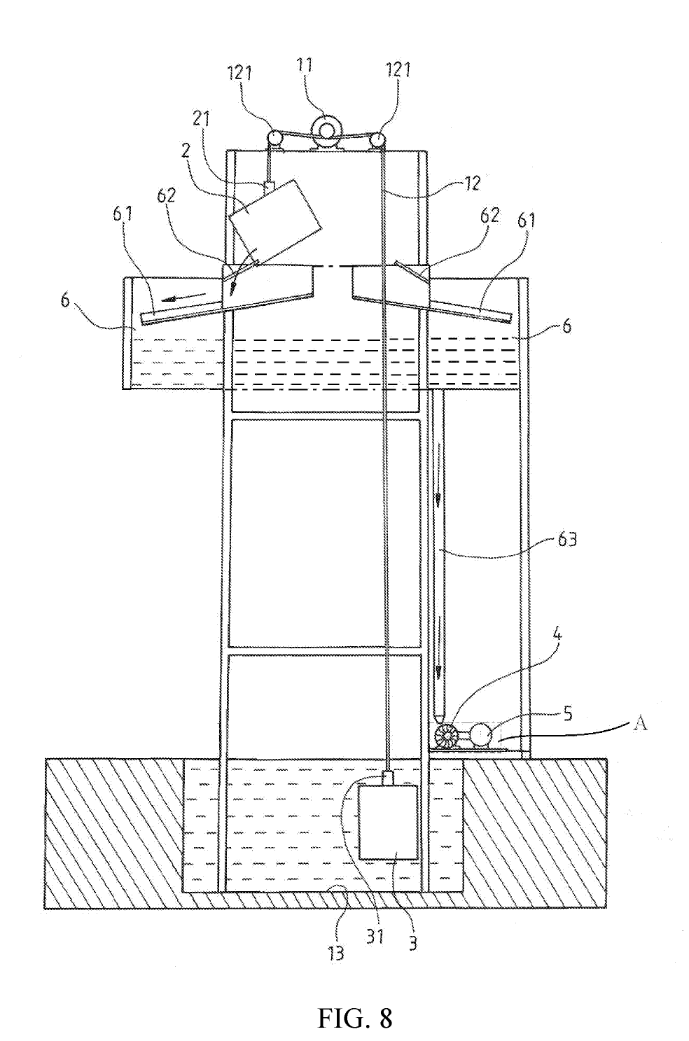

Referring to FIG. 7, another schematic view is given to illustrate an operation of the present invention. Reference being also had to FIGS. 4 and 5, as shown in the drawings, after the movement discussed above has been done, the drive unit 11 rotates reversely to drive the second bucket 3 to move so as to carry the second bucket 3 that is now filled up with water to the upper part of the tower frame 1, wherein when the second bucket 3 passes through the stop piece 32 arranged at the upper part of the tower frame 1, the engagement thereof with the stop piece 32 makes the second bucket 3 rotate downward by an angle to have water poured into the water chute 31 to flow into the water storage tank 6 and then flow downward along the pipe 63 to impact and drive the kinetic energy generation unit A to generate kinetic energy. Water that flows down along the pipe 63 is then allowed to flow back into the water storage trough 13 in order to cyclically repeat the operation of having the first bucket 2 and the second bucket 3 carrying water to thereby achieve an effect of cyclic generation of kinetic energy.

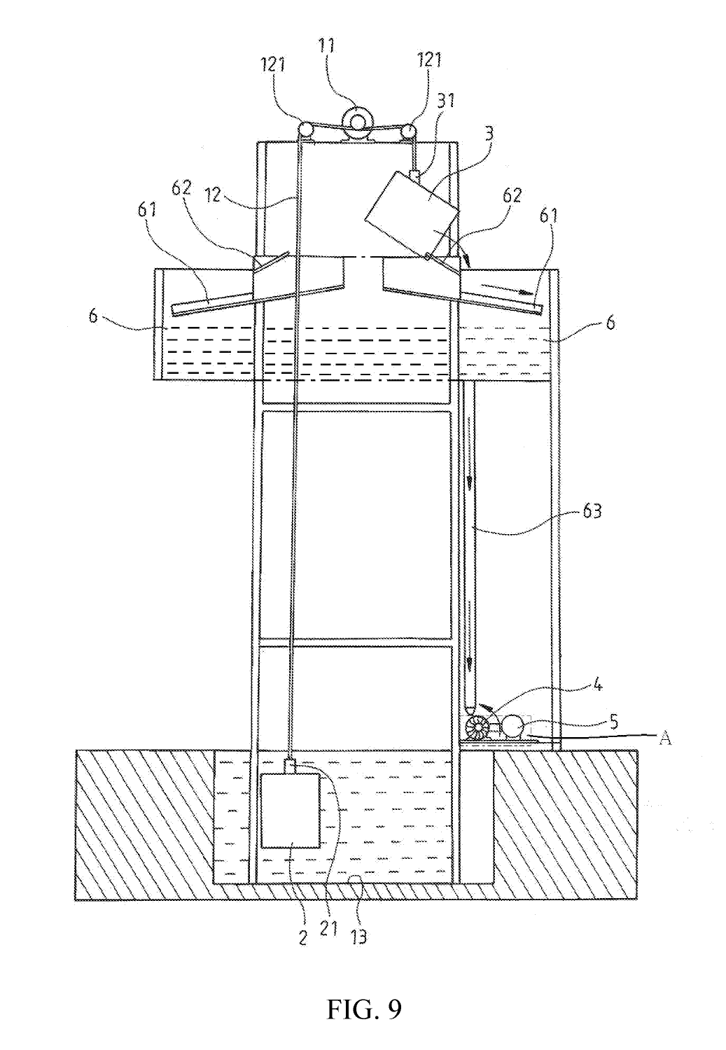

Referring collectively to FIGS. 8 and 9, schematic views are given to illustrate an operation of another embodiment of the present invention. As shown in the drawings, in another embodiment of the present invention, a tower frame 1 is provided and a drive unit 11 (a variable frequency drive motor) is mounted to a top of the tower frame 1. A cable 12 is coupled to the drive unit 11 and arranged in such a way that the cable 12 extends over idle pulleys 121 to have two ends of the cable 12 respectively coupled to a first bucket 2 and a second bucket 3. The tower frame 1 has a bottom in which a water storage trough 13 is provided. A kinetic energy generation unit A is mounted atop the water storage trough 13 and comprises a rotary mechanism 4. The rotary mechanism 4 is coupled to a power generation unit 5. In the instant embodiment, the rotary mechanism 4 comprises a plurality of blades and the power generation unit 5 comprises a dynamo. The drive unit 11 drives the first bucket 2, the second bucket 3 to move in such a way that, with the first bucket 2 and the second bucket 3 being counterweight of each other, the first bucket 2 the second bucket 3 are alternately moved up and down to carry water from the water storage trough 13 to a location at an upper part of the tower frame 1 to be poured into the water storage tank 6, whereby water received in the water storage tank 6 is allowed to rush down along the pipe 63 to impact and drive the rotary mechanism 4 to rotate and thus drive the power generation unit 5 to generate electrical power. The electrical power generated by the power generation units 5 is partly supplied to the drive unit 11 mounted atop the tower frame 1, while the remaining electrical power can be supplied to various sorts of electrical appliances that are not shown in the drawings. Water that flows down along the pipe 63 is then allowed to flow back into the water storage trough 13 to achieve the purpose of generating kinetic energy and also to serve as electrical power generation.

In summary, the present invention comprises buckets, which are arranged on a tower frame to be alternately moved up and down and are operated in combination with a water storage trough and water storage tank arranged in association with the tower frame, as well as a kinetic energy generation unit, to constitute a tower-based kinetic energy generation method and a device thereof. Through water impacting the kinetic energy generation unit, kinetic energy is generated, and also used for generation of electrical power, so as to achieve the purposes of energy saving and environment protection.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A tower-based kinetic energy generation device, comprising:
a tower frame, which has a bottom in which a water storage trough is formed and a kinetic energy generation unit is arranged; and
a first bucket and a second bucket, which are mounted to the tower frame to be alternately movable up and down along the tower frame;
wherein the first bucket and the second bucket each carry water to an upper part of the tower frame to allow water to rush down to impact and drive the kinetic energy generation unit to generate kinetic energy.

2. The tower-based kinetic energy generation device according to claim 1, wherein
the tower frame comprises a drive unit mounted to a top thereof and a cable is coupled to the drive unit, the cable having two ends respectively provided with the first bucket and the second bucket, the water storage trough being formed in the bottom of the tower frame, the kinetic energy generation unit being arranged above the water storage trough, the tower frame comprising a water storage tank mounted thereto, an inclined water chute being arranged above the water storage tank associated with each of the first and second buckets, an inclined stop piece being arranged above the water chute, the water storage tank having a bottom from which a pipe extends to a location above and corresponding to the kinetic energy generation unit;
the first bucket and the second bucket each have a bottom wall in which an opening is formed and which has an inside surface on which a retention member is mounted, a valve plate being rotatably coupled to the retention member so as to make the valve plate movable with the retention member being a support point, wherein the valve plate is selectively moved into and fit in the opening or moved upward to disengage from the opening; and
the drive unit drives the first bucket and the second bucket to alternately move up and down to carry water from the water storage trough to an upper part of the tower frame so that engagement thereof with the stop piece causes water to be poured into the water storage tank, allowing water to rush down along the pipe to impact and drive the kinetic energy generation unit to generate kinetic energy.

3. The tower-based kinetic energy generation device according to claim 2, wherein the drive unit mounted to the top of the tower frame comprises a variable frequency drive motor.

4. The tower-based kinetic energy generation device according to claim 1, wherein the kinetic energy generation unit comprises a rotary mechanism and a power generation unit to selectively generate electrical power.

5. The tower-based kinetic energy generation device according to claim 2, wherein the first bucket and the second bucket each comprise an inverted U-shaped handle, the handle having two ends rotatably coupled to two sides of the bucket to show a movable arrangement, the handle being coupled to the cable.

6. The tower-based kinetic energy generation device according to claim 2, wherein the first bucket and the second bucket each comprise a stop plate horizontally extending from a side wall thereof to be located above the valve plate to engage and thus prevent the valve plate from being rotated by an excessive angle that prevents returning of the valve plate.
